(19) United States
(12) Patent Application Publication
(10) Pub. No.: US 2005/0144011 A1
(43) Pub. Date: Jun. 30, 2005

(54) Vehicle mounted unit, voiced conversation document production server, and navigation system utilizing the same

(75) Inventor: Yuta Kawana, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 10/979,118

(22) Filed: Nov. 3, 2004

(30) Foreign Application Priority Data
Dec. 26, 2003 (JP) 2003-433271

(51) Int. Cl. G10L 19/00

(52) U.S. Cl. 704/277

(57) ABSTRACT

Navigation system includes vehicle mounted unit, voiced conversation document production server and information retrieval server, and the vehicle mounted unit produces and transmits to the server a request including recognized word and present position information acquired from a position detection part when evaluation by a driving performance evaluation part satisfies a predetermined reference, and the voiced conversation document production server searches information retrieval server using information retrieval word based on the recognized word included in the request, and buries acquired information in a voiced conversation document by voiced conversation document production part and transmits the voiced conversation document to the vehicle mounted unit, then the vehicle mounted unit analyzes voiced conversation document transmitted from the server and performs voiced conversation by voiced conversation parts and outputs result by voice synthesis part and synthesized voice output part.

### BACKGROUND OF THE INVENTION

1. Field of the Invention

The present invention relates to a vehicle mounted unit, a voiced conversation document production server and a navigation system utilizing the same, and in particular, a technology for providing a user with appropriate information in response to the conversation of a passenger in a vehicle.

2. Description of the Related Art

A vehicle mounted information terminal that is mounted in a vehicle and provides a passenger with various kinds of information and an information provision system provided with this information terminal have been conventionally known (for example, see patent document 1). In this vehicle mounted information terminal and the information provision system provided with this terminal, when a fact is detected by position data, that an area shown by the position data of character information received by a teletext broadcasting reception part, is included in a road map being now displayed on a display part, the display part is controlled by a vehicle mounted control part to display a reception mark showing that area on the road map being now displayed, and further a local data base part is controlled by the vehicle mounted control part to store the character information of that area. And if any reception mark is selected while the reception mark is being displayed, the character information of the area which correspond to the reception mark that is selected by the vehicle mounted control part, is read from the local data base part and displayed on the display part. With this arrangement, it can be easily to judge information of which area is received and to know the information about a desired area from the received various information.

On the other hand, in recent years has been also developed an conversation type car navigation system that recognizes an instruction by voice to operate according to the instruction and to return response synthesized by voice and image. As a device utilizing technologies of voice recognition and voice output has been known a conversation device that can realize conversation which gives a feeling of having the conversation with an actual human being by means of, for example, computer graphics and voice recognition and voice synthesis (for example, see patent document 2). This conversation device includes: a voice input part to which a user inputs voice; a voice recognition part that recognizes the input voice; a response sentence composing part that composes a response sentence from the recognized voice; a voice synthesis part that converts the composed response sentence to synthesized voice; a synthesized voice output part that outputs the synthesized voice; an image generation part that generates the image of a robot which performs various actions corresponding to the composed response sentences; an image display part that displays the generated image on a display device; and a data storage part that stores the model data of collection of the response sentences, robot data, and personal information data which are necessary data for these processing. According to this conversation device, by the computer graphics and voice recognition and voice synthesis, conversation which gives a feeling of having the conversation with an actual human being can be realized.
[Patent document 1] Japanese Unexamined Patent Publication No. 11-37772
[Patent document 1] Japanese Unexamined Patent Publication No. 2000-259601

By the way, a navigation system in which a user have conversation with a vehicle mounted unit by means of voice to acquire desired information can be thought to be realized by a combination of the vehicle mounted unit disclosed in the patent document 1 and the conversation device disclosed in the patent document 2. In such a case, the vehicle mounted unit needs to perform voice recognition at all times and if the vehicle mounted unit is so structured as to perform the voice recognition at all times, it is thought that the vehicle mounted unit responds to also ambient noises and ordinary conversation in the vehicle, thereby it produces the result of recognition of a user's unintentional voice.

On the other hand, another vehicle mounted unit has been also known in which all the information that will be desired by the user is stored in the vehicle mounted unit and is suitably provided to the user. In the vehicle mounted unit like this, an enormous amount of information needs to be stored and the information goes out of date with the passage of time. Hence, when in a case that the stored information is not frequently updated, the vehicle mounted unit like this type, can not provide the user with the newest information. Therefore, in this type of vehicle mounted unit, it takes a great deal of time and labor to update the information and it is inevitable to increase cost.

### SUMMARY OF THE INVENTION

The present invention has been made to solve the above problems. The object of the invention is to provide a vehicle mounted unit and a voiced conversation document production server, which can realize to perform voiced conversation by voice recognition in consideration of ambient circumstances and can provide a user with the newest information by the voiced conversation, and a navigation system utilizing these.

To achieve the above described object, a vehicle mounted unit in accordance with the present invention includes: a voice recognition part that recognizes input voice to output the input voice as a recognized word; a position detection part that detects a present position of a vehicle and outputs the present position as present position information; a driving performance evaluation part that evaluates driving performance; a control part that produces a voiced conversation document production request which includes the recognized word acquired from the voice recognition part and the present position information acquired from the position detection part when the recognized word is acquired from the voice recognition part and when evaluation by the driving performance evaluation part satisfies a predetermined reference; a transmission part that transmits the voiced conversation document production request which is produced by the control part to the outside; a reception part that receives a voiced conversation document which is transmitted from the outside in response to transmission from the transmission part; a voiced conversation document analysis part that analyzes the voiced conversation document which is received by the reception part; a voiced conversation part that performs voiced conversation according to an analysis result by the voiced conversation document analysis part; and a synthesized voice output part that outputs a result which is derived from the voiced conversation by the voiced conversation part.

Further, a voiced conversation document production server in accordance with the present invention includes: a reception part that receives a voiced conversation document production request which is transmitted from a moving body and includes a recognized word and present position information of the moving body; an information retrieval part that searches an external information retrieval server by use of an information retrieval word which is produced on a basis of the recognized word included in the voiced conversation document production request received by the reception part; a voiced conversation document production part that produces a voiced conversation document including information retrieved from the external information retrieval server by the information retrieval part in response to the voiced conversation document production request received by the reception part; and a transmission part that transmits the voiced conversation document produced by the voiced conversation document production part.

Still further, a navigation system in accordance with the present invention includes: a vehicle mounted unit, a voiced conversation document production server; and an information retrieval server, wherein the vehicle mounted unit includes: a voice recognition part that recognizes input voice to output the input voice as a recognized word; a position detection part that detects a present position of a vehicle and outputs the present position as present position information; a driving performance evaluation part that evaluates driving performance; a control part that produces a voiced conversation document production request which includes the recognized word acquired from the voice recognition part and the present position information acquired from the position detection part when the recognized word is acquired from the voice recognition part and when evaluation by the driving performance evaluation part satisfies a predetermined reference; a first transmission part that transmits the voiced conversation document production request which is produced by the control part to the outside; a first reception part that receives a voiced conversation document which is transmitted from the voiced conversation document production server in response to transmission from the first transmission part; a voiced conversation document analysis part that analyzes the voiced conversation document which is received by the first reception part; a voiced conversation part that performs voiced conversation according to an analysis result by the voiced conversation document analysis part; and a synthesized voice output part that outputs a result which is derived from the voiced conversation by the voiced conversation part, and wherein the voiced conversation document production server includes: a second reception part that receives the voiced conversation document production request which is transmitted from the vehicle mounted unit; an information retrieval part that searches the information retrieval server by use of an information retrieval word which is produced on a basis of the recognized word included in the voiced conversation document production request received by the second reception part; a voiced conversation document production part that produces a voiced conversation document including information retrieved from the information retrieval server by the information retrieval part in response to the voiced conversation document production request received by the second reception part; and a second transmission part that transmits the voiced conversation document produced by the voiced conversation document production part to the vehicle mounted unit.

The vehicle mounted unit in accordance with the present invention is so structured as to produce a voiced conversation document production request and to transmit the request to the outside in a case where the recognized word is acquired from the voice recognition part and where evaluation by the driving performance evaluation part satisfies the predetermined reference. Hence, if the ambient noises are large and, even if ordinary conversation is performed in the vehicle, the evaluation by the driving performance evaluation part does not satisfy the predetermined reference, the voiced conversation document production request is not transmitted to the outside. Therefore, the voiced conversation can be performed by the voice recognition considering the ambient circumstances and hence a user's unintentional voiced conversation is not started and a result derived from the voiced conversation is not output, either.

According to the voiced conversation document production server in accordance with the present invention, in a case where the voiced conversation document production request is received from the outside, the voiced conversation document including the information retrieved from the external information retrieval server can be produced. Hence, it is possible to produce a voiced conversation document based on the newest information. Therefore, the newest information is always derived by the voiced conversation performed on a basis of the voiced conversation document and hence, the user can be provided with the newest information.

According to the navigation system in accordance with the present invention, it is possible to provide a navigation system having advantages of both of the vehicle mounted unit and the voiced conversation document production server.

### BRIEF DESCRIPTION OF THE DRAWINGS

FIG. 1 shows the general structure of a navigation system in accordance with embodiment 1 of the present invention.

FIG. 2 is a block diagram to show the detailed structure of the navigation system in accordance with embodiment 1 of the present invention.

FIG. 3 is a flow chart to show a processing procedure from voice recognition to the transmission of a voiced conversation document production request to the voiced conversation document production server, which are performed by the vehicle mounted unit.

FIG. 4 is a flow chart to show the operation of the voiced conversation document production server which receives the voiced conversation document production request from the vehicle mounted unit.

FIG. 5 is a flow chart to show a processing procedure by which the vehicle mounted unit receives a voiced conversation document from the voiced conversation document production server and performs voiced conversation.

### DETAILED DESCRIPTION OF THE PREFERRED EMBODIMENT

Hereafter, the preferred embodiment of the present invention will be described in detail with reference to the drawings.

### Embodiment 1

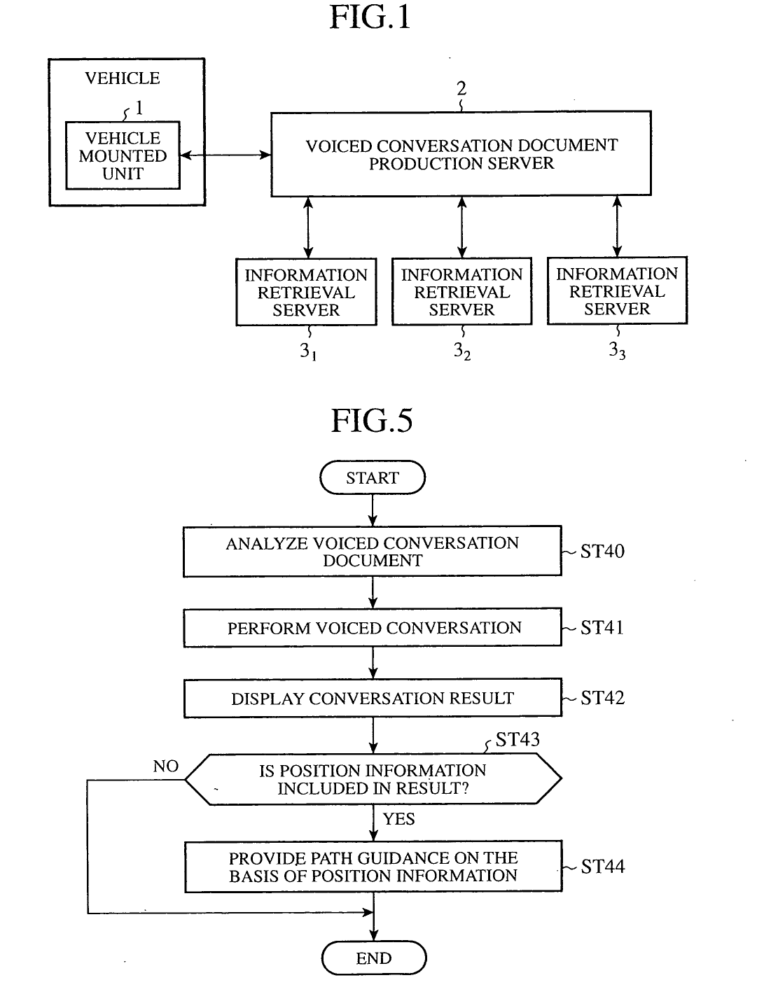

First, an outline of the navigation system in accordance with embodiment 1 of the present invention will be described. FIG. 1 shows the general structure of the navigation system in accordance with embodiment 1 of the present invention. This navigation system is composed of a vehicle mounted unit 1 which is mounted in a vehicle, a voiced conversation document production server 2, and a plurality of information retrieval servers 31, 32, 33 (hereinafter they are typified by a reference numeral “3”). The vehicle mounted unit 1 is connected to the voiced conversation document production server 2 through a wireless communication line. Further, the voiced conversation document production server 2 is connected to the plurality of information retrieval servers 3 through wireless communication lines or wired communication lines.

The vehicle mounted unit 1 produces a voiced conversation document production request which includes a recognized word acquired by recognizing voice uttered in a vehicle and the present position information of the vehicle, and sends the voiced conversation document production request to the voiced conversation document production server 2. Further, the vehicle mounted unit 1 performs voiced conversation with a user by voice according to a voiced conversation document which is sent from the voiced conversation document production server 2 and provides the user with appropriate information according to the result of this voiced conversation. The detailed structure of this vehicle mounted unit 1 will be later described.

The voiced conversation document production server 2 produces the voiced conversation document according to the voiced conversation document production request which is sent from the vehicle mounted unit 1. The voiced conversation document is a document in which the sequence of conversation between the vehicle mounted unit 1 and the user is described. Further, when this voiced conversation document production server 2 produces the voiced conversation document, the voiced conversation document production server 2 searches the information retrieval server 3 by use of an information retrieval word that is produced on a basis of the recognized word and the present position information of the vehicle, which are included in the voiced conversation document production request. The voiced conversation document production server 2 incorporates information acquired from the information retrieval server 3 into the voiced conversation document. The voiced conversation document produced by the voiced conversation document production server 2 is transmitted to the vehicle mounted unit 1. The detailed structure of this voiced conversation document production server 2 will be later described.

The information retrieval server 3 is composed of, for example, various servers which are connected to a network. The information retrieval server 3 retrieves information related to the information retrieval word which is sent from the voiced conversation document production server 2 from information stored therein and sends the retrieved information to the voiced conversation document production server 2.

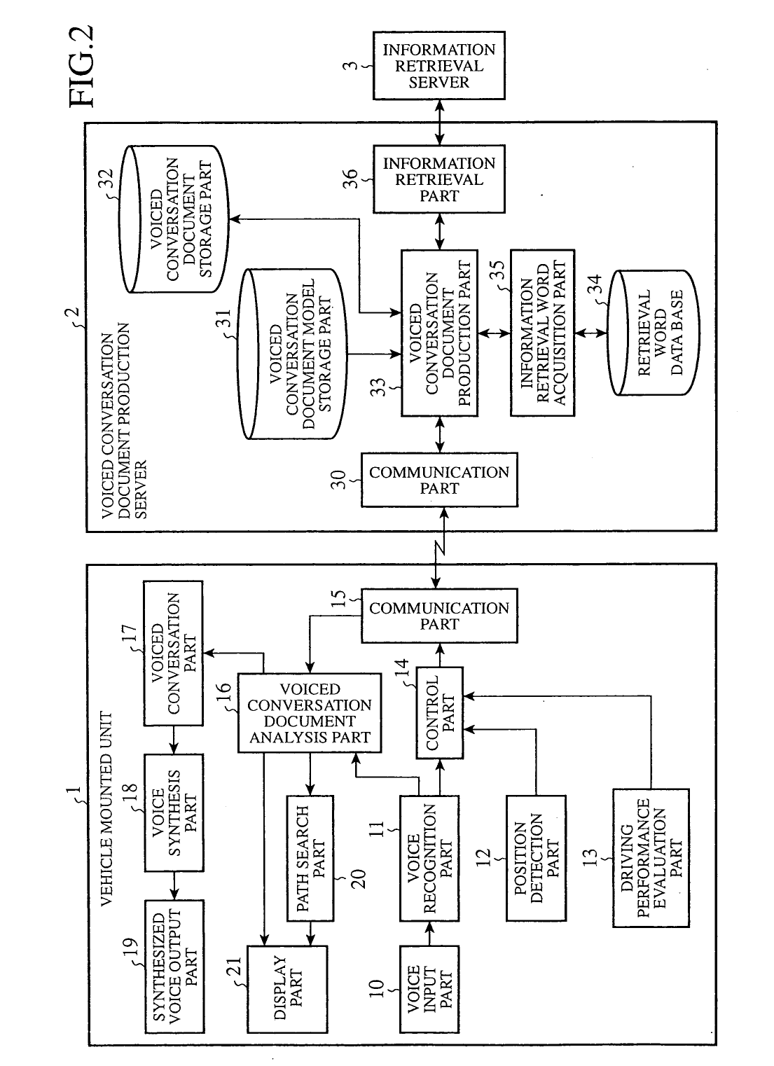

Next, the detailed structure of the navigation system structured in the manner described above will be described. FIG. 2 is a block diagram to show the detailed structure of navigation system in accordance with embodiment 1 of the present invention.

First, the vehicle mounted unit 1 will be described. The vehicle mounted unit 1 is composed of a voice input part 10, a voice recognition part 11, a position detection part 12, a driving performance evaluation part 13, a control part 14, a communication part (transmission part and reception part, or first transmission part and first reception part) 15, a voiced conversation document analysis part 16, a voiced conversation part 17, a voice synthesis part 18, a synthesized voice output part 19, a path search part 20, and a display part 21.

The voice input part 10 is composed of, for example, a microphone, an amplifier and the like, and collects the conversation of passenger in the vehicle and produces a voice signal. The voice signal produced by the voice input part 10 is sent to the voice recognition part 11.

The voice recognition part 11 performs a voice recognition processing to the voice signal sent from the voice input part 10. A recognized word which is recognized by the voice recognition processing in the voice recognition part 11 is sent to the control part 14 if voiced conversation is not being conducted or to the voiced conversation document analysis part 16 if the voiced conversation is being conducted.

The position detection part 12 detects the present position of the vehicle. The position detection part 12 includes a GPS receiver, a direction sensor, a distance sensor and the like, although they are not shown in the drawing, and can always detect the present position of the vehicle irrespective of the surrounding circumstances. Present position information showing the present position of the vehicle which is detected by the position detection part 12 is sent to the control part 14.

The driving performance evaluation part 13 digitalizes and stores a driving performance of driver of the vehicle. For example, the driving performance evaluation part 13 detects the continuous running time, the number of times of braking, the number of curves and the like of the vehicle by means of various kinds of sensors provided in the vehicle and evaluates the degree of fatigue of the driver for a maximum of, for example, 1000 marks on a basis of these detection results and stores the degree of fatigue of the driver as an evaluation point. The evaluation point stored in this driving performance evaluation part 13 is read by the control part 14.

When the control part 14 acquires the recognized word from the voice recognition part 11, the control part 14 reads the evaluation point from the driving performance evaluation part 13 and compares the evaluation point with a predetermined reference value to determine conditions of the driver. In a case where the evaluation point exceeds the reference value, that is, evaluation satisfies the predetermined reference, the control part 14 produces a voiced conversation document production request which includes the present position information acquired from the position detection part 12 and the recognized word, and sends the voiced conversation document production request to the voiced conversation document production server 2 via the communication part 15.

The communication part 15 controls communications between the vehicle mounted unit 1 and the voiced conversation document production server 2. That is, the communication part 15 transmits the voiced conversation document production request sent from the control part 14 and includes the recognized word and the present position information to the voiced conversation document production server 2 by radio communication and receives the voiced conversation document which is sent from the voiced conversation document production server 2 by radio communication and sends the voiced conversation document to the voiced conversation document analysis part 16.

The voiced conversation document analysis part 16 analyzes the voiced conversation document which is received from the voiced conversation document production server 2 via the communication part 15 and sends analysis results to the voiced conversation part 17. Further, the voiced conversation document analysis part 16 performs a processing of advancing the voiced conversation when the voiced conversation document analysis part 16 receives the recognized word from the voice recognition part 11 during voiced conversation. Still further, the voiced conversation document analysis part 16 displays results which is derived from the voiced conversation on the display part 21 to provide the user with information. Still further, in a case where the information provided to the user includes information showing a position, the voiced conversation document analysis part 16 instructs the path search part 20 to search a path to a destination of the position or a path passing the position.

The voiced conversation part 17 performs a processing for realizing voiced conversation on a basis of the analysis results which is sent from the voiced conversation document analysis part 16. Processing results in the voiced conversation part 17 are sent as voice data to the voice synthesis part 18.

The voice synthesis part 18 performs a voice synthesis processing on a basis of voice data sent from the voiced conversation part 17 to produce a voice signal. The voice signal produced by this voice synthesis part 18 is sent to the synthesized voice output part 19. The synthesized voice output part 19 is composed of, for example, a speaker and generates voice according to the voice signal from the voice synthesis part 18.

When the path search part 20 is instructed to search a path by the voiced conversation document analysis part 16, the path search part 20 searches a path to a destination or a stopover from the present position and provides guidance according to the searched path. Path data and guidance data which are acquired by the path search part 20 searching a path are sent to the display part 21.

The display part 21 is composed of, for example, a liquid crystal display and displays information that is sent from the voiced conversation document analysis part 16 and is to be provided to the user, displays a path based on the path data that is sent from the path search part 20, and displays a guidance message based on the guidance data that is sent from the path search part 20. When the user looks at this display part 20, the user can see information derived from the results of voiced conversation, the path to the destination or the stopover set on a basis of the results of voiced conversation and the guidance message.

Next, the voiced conversation document production server 2 will be described. The voiced conversation document production server 2 is composed of a communication part (transmission part and reception part, or second transmission part and second reception part) 30, a voiced conversation document model storage part 31, a voiced conversation document storage part 32, a voiced conversation document production part 33, a retrieval word data base 34, an information retrieval word acquisition part 35, and an information retrieval part 36.

The communication part 30 controls communications between the voiced conversation document production server 2 and the vehicle mounted unit 1. That is, the communication part 30 receives the voiced conversation document production request which is sent from the vehicle mounted unit 1 by radio communication and which includes the recognized word and the present position information and sends the voiced conversation document production request to the voiced conversation document production part 32 and receives the voiced conversation document which is produced by the voiced conversation document production part 32 and sends the voiced conversation document to the vehicle mounted unit 1 by radio communication.

The voiced conversation document model storage part 31 stores voiced conversation document models. The voiced conversation document model is original data to produce a voiced conversation document and is composed of a sequence of conversation for a certain event. For example, one example of voiced conversation document model which is composed of five sequences (1) to (5) for an event of urging a user to take a rest will be described below.
(1) vehicle mounted unit: Do you take a rest?
(2) user: Yes, I do.
(3) vehicle mounted unit: Do you drop in a near road station?
(4) user: Yes, I do.
(5) vehicle mounted unit: I set “xxxx” at a stopover.

Apart shown by “xxxx” in this voiced conversation document model is an uncertain part and is dynamically determined on a basis of the present position of the vehicle and information acquired by the information retrieval part 36. The contents of this voiced conversation document model storage part 31 are read by the voiced conversation document production part 33.

At this point, the term “road station” means a facility for rest that is provided on an ordinary road to be utilized with a feeling of safety so as to support a smooth traffic flow in an increasing tide of long distance drive and drivers of women and elderly people. To be more specific, the “road station” means a rest facility which has three functions of a rest function for road users, a function of providing information to road users and people in the area, and an area association function of promoting association between towns in the area by use of the road station.

The voiced conversation document storage part 32 stores a voiced conversation document which is produced by the voiced conversation document production part 33.

The voiced conversation document production part 33 buries appropriate words in the uncertain part in the voiced conversation document model which is read from the voiced conversation document model storage part 31 to produce a voiced conversation document. The voiced conversation document which is produced by the voiced conversation document production part 33 is stored in the voiced conversation document storage part 32. Further, the voiced conversation document production part 33 reads the voiced conversation document which is stored in the voiced conversation document storage part 32 and transmits the voiced conversation document to the vehicle mounted unit 1 via the communication part 30.

The retrieval word data base 34 stores information retrieval words which is related to recognized words included in the voiced conversation document production request sent from the vehicle mounted unit 1. For example, the retrieval word data base 34 stores information retrieval words such as “rest site”, “road station”, and “service area” in relation to a recognized word of “tired”. The content of this retrieval word database 34 is read by the information retrieval word acquisition part 35.

When a recognized word is sent from the voiced conversation document production part 33, the information retrieval word acquisition part 35 acquires information retrieval words which corresponds to the recognized word from the retrieval word data base 34 and sends the information retrieval words to the voiced conversation document production part 33. For example, when the recognized word of “tired” is sent from the voiced conversation document production part 33, the information retrieval word acquisition part 35 searches the retrieval word data base 34 and acquires the information retrieval words such as “rest site”, “road station”, and “service area” and sends them to the voiced conversation document production part 33.

When an information retrieval word is sent from the voiced conversation document production part 33, the information retrieval part 36 searches the information retrieval server 3 by use of the information retrieval word. Information acquired by this retrieval is sent to the voiced conversation document production part 33.

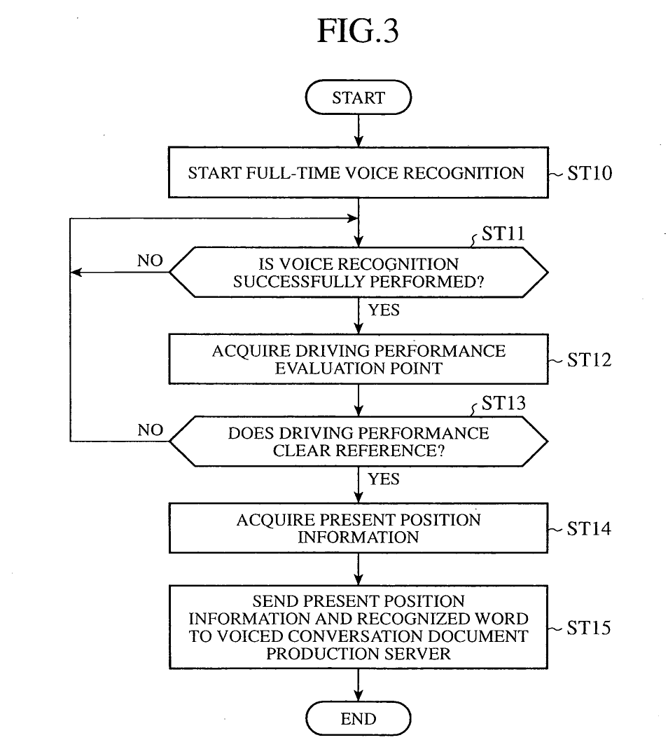

Next, the operation of navigation system in accordance with embodiment 1 of the present invention will be described with reference to a flow chart shown in FIG. 3 to FIG. 5. An operation in a case where a driver utters a word of “tired” in a vehicle will be described below by way of example.

FIG. 3 is a flow chart to show a processing procedure from voice recognition to the transmission of a voiced conversation document production request to the voiced conversation document production server 2, which are always performed by the vehicle mounted unit 1.

First, when an operating panel (not shown) of the vehicle mounted unit 1 is operated, start of full-time voice recognition is set (step ST10). With this, conversation in the vehicle is always collected by the voice input part 10 and is sent to the voice recognition part 11.

Next, it is checked whether or not voice recognition successfully performed (step ST11). That is, the voice recognition part 11 performs a voice recognition processing to a voice signal which is sent from the voice input part 10 to check whether or not voice recognition is successfully performed. At this point, if it is determined that the voice recognition is not successfully performed, while repeating step ST11, the sequence waits until the voice recognition is successfully performed. Then, when the voice recognition is successfully performed in the course of repeating step ST11 and it is determined that a recognized word of “tired” is acquired, the evaluation point of driving performance is acquired (step ST12). That is, when the control part 14 acquires the recognized word of “tired” from the voice recognition part 11, the control part 14 acquires an evaluation point stored in the driving performance evaluation part 13.

Next, it is checked whether or not the driving performance clears (satisfies) a reference (step ST13). That is, the control part 14 checks whether or not the evaluation point acquired from the driving performance evaluation part 13 is larger than a predetermined reference value. If it is determined at this step ST13 that the driving performance does not clear the reference, in other words, that the evaluation point does not satisfy the predetermined reference value, it is recognized that the driver is not yet tired and the driver does not need to be provided with information, and the sequence returns to step ST11. Then, the above described processing is repeated.

On the other hand, if it is determined at step ST13 that the driving performance clears the reference, in other words, that the evaluation point is larger than the predetermined reference value, it is recognized that the driver is tired and needs to be supplied with information, and present position information is acquired (step ST14). That is, the control part 14 acquires the present position information of the vehicle from the position detection part 12.

Next, the control part 14 produces a voiced conversation document production request including the acquired present position information acquired at step ST14 and the recognized word of “tired” and transmits the voiced conversation document production request to the voiced conversation document production server 2 via the communication part 15 (step ST15). Thereafter, although it is not shown in the drawing, the vehicle mounted unit 1 waits for the reception of the voiced conversation document from the voiced conversation document production server 2.

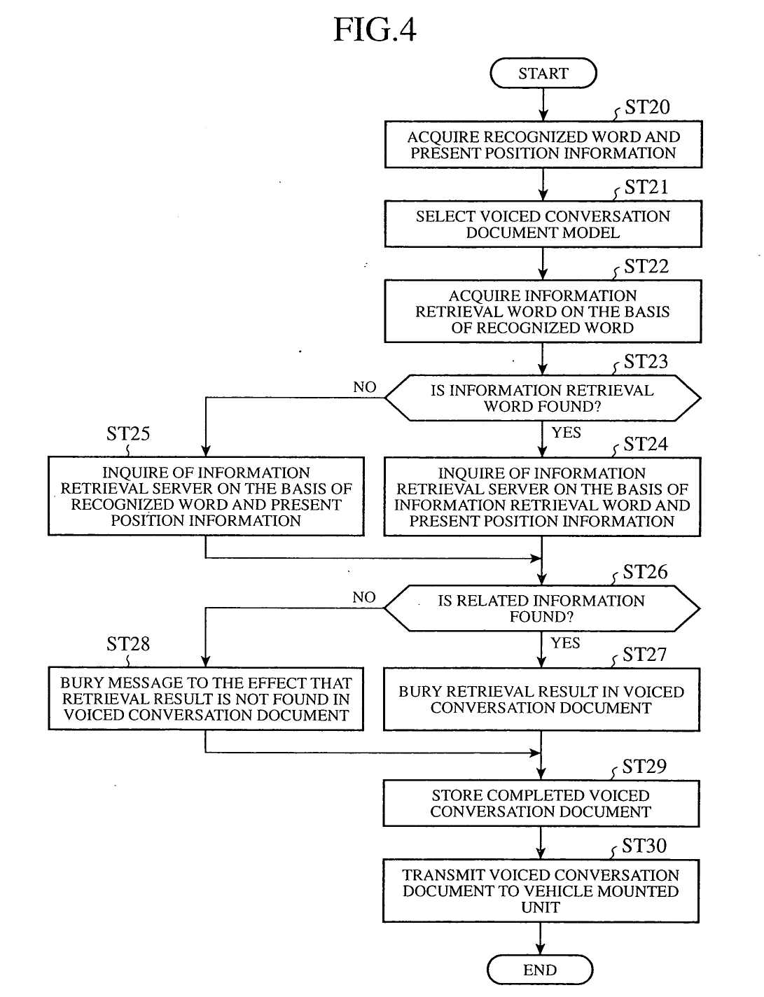

FIG. 4 is a flow chart to show a processing procedure that the voiced conversation document production server 2 which has received the voiced conversation document production request from the vehicle mounted unit 1 produces voiced conversation document and transmits the voiced conversation document to the vehicle mounted unit 1.

The voiced conversation document production server 2, first, acquires the recognized word and the present position information that are included in the voiced conversation document production request (step ST20). That is, the voiced conversation document production part 33 acquires the recognized word and the present position information that are included in the voiced conversation document production request which is received from the vehicle mounted unit 1 via the communication part 30.

Next, a voiced conversation document model is selected (step ST21). That is, the voiced conversation document production part 33 selects and reads a voiced conversation document model which is related to the recognized word of “tired” from the voiced conversation document model storage part 31.

Next, an information retrieval word is acquired on a basis of the recognized word (step ST22). To be specific, the voiced conversation document production part 33 sends the recognized word to the information retrieval word acquisition part 35 and instructs the information retrieval word acquisition part 35 to retrieve the information retrieval word which corresponds. The information retrieval word acquisition part 35 searches the retrieval word data base 34 in response to the instruction from the voiced conversation document production part 33. If the information retrieval word acquisition part 35 finds the information retrieval words corresponding to the recognized word, the information retrieval word acquisition part 35 returns the information retrieval words such as “rest site”, “road station”, and “service area” as retrieval results to the voiced conversation document production part 33.

Next, it is checked whether or not the information retrieval word is found (step ST23). That is, the voiced conversation document production part 33 checks whether or not the retrieval result which is received from the information retrieval word acquisition part 35 shows that the information retrieval word is found.

If it is determined at this step ST 23 that the information retrieval word is found, an inquiry is made to the information retrieval server 3 on a basis of the information retrieval word and the present position information (step ST24). To be specific, the voiced conversation document production part 33 sends the information retrieval word and the present position information to the information retrieval part 36 and instructs the information retrieval part 36 to retrieve information which relates to these. Thereafter, the sequence proceeds to step ST26. With this, the information retrieval part 36 accesses the information retrieval server 3 to try to acquire information related to the information retrieval word and the present position information. If there is the related information, the information retrieval part 36 returns the related information as a retrieval result to the voiced conversation document production part 33.

On the other hand, if it is determined at step ST23 that the information retrieval word is not found, an inquiry is made to the information retrieval server 3 on a basis of the recognized word and the present position information (step ST25). To be specific, the voiced conversation document production part 33 sends the recognized word and the present position information to the information retrieval part 36 and instructs the information retrieval part 36 to retrieve information which relates to these. Thereafter, the sequence proceeds to step ST26. With this, the information retrieval part 36 accesses the information retrieval server 3 to try to acquire information related to the information retrieval word and the present position information. If there is the related information, the information retrieval part 36 returns the information as a retrieval result to the voiced conversation document production part 33.

It is checked at step ST26 whether or not the related information is found. That is, the voiced conversation document production part 33 checks whether or not the retrieval result received from the information retrieval part 36 shows that the related information is found.

If it is determined at this step ST26 that the related information is found, the related information acquired as the retrieval result is buried in a voiced conversation document model (step ST27). In the example described above, the voiced conversation document production part 33 buries the name of a road station in the part of “xxxx” of the voiced conversation document model. Thereafter, the sequence proceeds to step ST29.

On the other hand, if it is determined at this step ST26 that the related information is not found, a message to the effect is buried in the voiced conversation document model (step ST28). In the example described above, the voiced conversation document production part 33 buries a message to the effect that a road station is not found in the part of “xxxx” of the voiced conversation document model. Thereafter, the sequence proceeds to step ST29.

At step ST29, the voiced conversation document which is completed at step ST27 or ST28 is stored. That is, the voiced conversation document production part 33 stores the voiced conversation document completed by the information being buried at step ST27 or ST28 in the voiced conversation document storage part 32.

Next, the voiced conversation document is transmitted to the vehicle mounted unit 1 (step ST30). That is, the voiced conversation document production part 33 reads the voiced conversation document stored at step ST29 from the voiced conversation document storage part 32 and transmits the voiced conversation document to the vehicle mounted unit 1 via the communication part 30. With this, the processing of the voiced conversation document production server 2 is finished.

FIG. 5 is a flow chart to show a processing procedure by which the vehicle mounted unit 1 receives a voiced conversation document from the voiced conversation document production server 2 and performs voiced conversation.

The vehicle mounted unit 1, first, analyzes the voiced conversation document (step ST40). That is, when the control part 14 receives the voiced conversation document from the voiced conversation document production server 2 via the communication part 15, the control part 14 sends the voiced conversation document to the voiced conversation document analysis part 16. With this, the voiced conversation document analysis part 16 analyzes the voiced conversation document.

Next, voiced conversation is performed (step ST41). That is, the voiced conversation document analysis part 16 sends an analysis result to the voiced conversation part 17. With this, the voiced conversation part 17 produces voice data and sends the voice data to the voice synthesis part 18 and the voice synthesis part 18 produces a voice signal on a basis of the voice data and sends the voice signal to the synthesized voice output part 19. With this, synthesized voice is output from the synthesized voice output part 19 to make a call to the user.

User's response to this call is converted to the voice signal by the voice input part 10 and is sent to the voice recognition part 11. The voice recognition part 11 performs the voice recognition processing on a basis of the voice signal which is input by the vice input part 10 and sends the recognized word to the voiced conversation document analysis part 16. The voiced conversation document analysis part 16 utters the next word described in the voiced conversation document on a basis of the recognized word. Thereafter, the utterance and the recognition of user's response are repeated until all the steps described in the voiced conversation document are completed.

Next, conversation results are displayed (step ST42). That is, when all the steps described in the voiced conversation document are completed, the voiced conversation document analysis part 16 displays results derived from the voiced conversation on the display part 21.

Next, it is checked whether or not position information (information to show a road station) is included in the results of the voiced conversation (step ST43). If it is determined that the position information is included in the results of the voiced conversation, path guidance is provided on a basis of the position information (step ST44). That is-, the voiced conversation document analysis part 16 instructs the path search part 20 to search a path to a destination or a stopover shown by the position information. The path search part 20 searches a path from the present position to the destination or a stopover and sends a search result to the display part 21. With this, the searched path, in other words, the path from the present position to the road station and path guidance are displayed on the display part 21.

As described above, according to the navigation system in accordance with embodiment 1 of the present invention, the vehicle mounted unit 1 produces a voiced conversation document production request and transmits the voiced conversation document production request to the voiced conversation document production server 2 only in a case where a recognized word is acquired from the voice recognition part 11 and where evaluation by the driving performance evaluation part 13 satisfies a predetermined reference. Hence, if ambient noises are large or, even if ordinary conversation is made in the vehicle, evaluation by the driving performance evaluation part 13 does not satisfy the predetermined reference, a voiced conversation document production request is not transmitted to the voiced conversation document production server 2. Therefore, a voiced conversation document is also not sent back from the voiced conversation document production server 2 and hence voiced conversation which is not intended by the user, is not started and a result derived from the unintentional voiced conversation is not output, either.

Further, according to the navigation system in accordance with embodiment 1 of the present invention, the voiced conversation document production server 2 produces a voiced conversation document including information retrieved from the external information retrieval server when the voiced conversation document production server 2 receives a voiced conversation document production request from the vehicle mounted unit 1, and hence can always produce the voiced conversation document on a basis of the newest information. Therefore, the newest information is always derived by the voiced conversation which is performed in the vehicle mounted unit 1 on a basis of the voiced conversation document and hence the user can be always provided with the newest information.

The navigation system in accordance with the present invention can be applied, not only to a vehicle but also to a ship, an airplane, other various kinds of moving bodies, and a portable phone.

1. A vehicle mounted unit comprising:
a voice recognition part that recognizes input voice to output the input voice as a recognized word;
a position detection part that detects a present position of a vehicle and outputs the present position as present position information;
a driving performance evaluation part that evaluates driving performance;
a control part that produces a voiced conversation document production request which includes the recognized word acquired from the voice recognition part and the present position information acquired from the position detection part when the recognized word is acquired from the voice recognition part and when evaluation by the driving performance evaluation part satisfies a predetermined reference;
a transmission part that transmits the voiced conversation document production request which is produced by the control part to the outside;
a reception part that receives a voiced conversation document which is transmitted from the outside in response to transmission from the transmission part;
a voiced conversation document analysis part that analyzes the voiced conversation document which is received by the reception part;
a voiced conversation part that performs voiced conversation according to an analysis result by the voiced conversation document analysis part; and
a synthesized voice output part that outputs a result which is derived from the voiced conversation by the voiced conversation part.

2. The vehicle mounted unit as claimed in claim 1, further comprising a path search part that searches a path to a destination, wherein the voiced conversation document analysis part instructs the path search part to search a path when the voiced conversation document received from the outside includes information showing a destination and wherein the synthesized voice output part outputs guidance of the path searched by the path search part.

3. The vehicle mounted unit as claimed in claim 1, wherein the driving performance evaluation part stores an evaluation point produced on a basis of information including a continuous running time, the number of times of braking, and the number of curves of the vehicle and wherein the control part compares the evaluation point with a predetermined reference value to determine whether or not the evaluation point satisfies the predetermined reference value.

4. A voiced conversation document production server comprising:
a reception part that receives a voiced conversation document production request which is transmitted from a moving body and includes a recognized word and present position information of the moving body;
an information retrieval part that searches an external information retrieval server by use of an information retrieval word which is produced on a basis of the recognized word included in the voiced conversation document production request received by the reception part;
a voiced conversation document production part that produces a voiced conversation document including information retrieved from the external information retrieval server by the information retrieval part in response to the voiced conversation document production request received by the reception part; and
a transmission part that transmits the voiced conversation document produced by the voiced conversation document production part.

5. The voiced conversation document production server as claimed in claim 4, further comprising a voiced conversation document model storage part that stores a voiced conversation document model, wherein the voiced conversation document production part reads a voiced conversation document model which is related to the recognized word included in the voiced conversation document production request from the voiced conversation document model storage part in response to the voiced conversation document production request received by the reception part and buries information which is retrieved from the external information retrieval server by the information retrieval part in the voiced conversation document model to produce the voiced conversation document.

6. The voiced conversation document production server as claimed in claim 4, further comprising;
a retrieval word data base that stores an information retrieval word for searching the external information retrieval server; and
an information retrieval word acquisition part that acquires the information retrieval word which is related to the recognized word included in the voiced conversation document production request received by the reception part from the retrieval word database, wherein the information retrieval part searches the external retrieval server by use of the information retrieval word acquired by the information retrieval word acquisition part.

7. A navigation system comprising:
a vehicle mounted unit,
a voiced conversation document production server; and
an information retrieval server,
wherein the vehicle mounted unit includes:
a voice recognition part that recognizes input voice to output the input voice as a recognized word;
a position detection part that detects a present position of a vehicle and outputs the present position as present position information;
a driving performance evaluation part that evaluates driving performance;
a control part that produces a voiced conversation document production request which includes the recognized word acquired from the voice recognition part and the present position information acquired from the position detection part when the recognized word is acquired from the voice recognition part and when evaluation by the driving performance evaluation part satisfies a predetermined reference;
a first transmission part that transmits the voiced conversation document production request which is produced by the control part to the outside;
a first reception part that receives a voiced conversation document which is transmitted from the voiced conversation document production server in response to transmission from the first transmission part;
a voiced conversation document analysis part that analyzes the voiced conversation document which is received by the first reception part;
a voiced conversation part that performs voiced conversation according to an analysis result by the voiced conversation document analysis part; and
a synthesized voice output part that outputs a result which is derived from the voiced conversation by the voiced conversation part,
wherein the voiced conversation document production server includes:
a second reception part that receives the voiced conversation document production request which is transmitted from the vehicle mounted unit;
an information retrieval part that searches the information retrieval server by use of an information retrieval word which is produced on a basis of the recognized word included in the voiced conversation document production request received by the second reception part;
a voiced conversation document production part that produces a voiced conversation document including information retrieved from the information retrieval server by the information retrieval part in response to the voiced conversation document production request received by the second reception part; and
a second transmission part that transmits the voiced conversation document produced by the voiced conversation document production part to the vehicle mounted unit.
